(19) United States
(12) Patent Application Publication
(10) Pub. No.: US 2012/0005295 A1
(43) Pub. Date: Jan. 5, 2012

(54) Method and Device for Mail Processing

(76) Inventors: Dianzhi Wang, Beijing (CN); Shuo Zhang, Beijing (CN); Shengdo Li, Beijing (CN)

(21) Appl. No.: 13/256,808

(22) PCT Filed: Mar. 2, 2010
(86) PCT No.: PCT/CN2010/070833

§ 371 Date: Sep. 15, 2011

(30) Foreign Application Priority Data
Mar. 17, 2009 (CN) 20091008004.1

(51) Int. Cl. G06F 15/16

(52) U.S. Cl. 709/206

(57) ABSTRACT

A method and device for mail processing are provided by embodiments of the present invention. The method comprises: acquiring a first description information of a first mail, wherein the first description information comprises a first mail content and a first display description information of the first mail content; acquiring a first format of the first mail and a second format of a second mail; converting the first mail content in the first format into a second mail content in the second format; converting the first display description information in the first format into a second display description information in the second format; obtaining the second mail according to a second description information comprising the second mail content and the second display description information, wherein the display of the second mail content within the second mail according to the second display description information is consistent with the display of the first mail content within the first mail according to the first display description information. The implementation of the technical solutions provided by the embodiments of the invention enables a user receiving the second mail to see the mail information comparatively consistent with the information intended to be expressed by the first mail.

### TECHNICAL FIELD OF THE INVENTION

The present invention relates to the field of information technology, especially to a method and device for mail processing.

### BACKGROUND OF THE INVENTION

Emails are widely used due to their capability of transmitting information rapidly. Accordingly, mail system providers often commit themselves to providing users with perfect technical services so as to meet requirements of the users, for example, providing a technical service of generating one type of mail according to another type of mail in some cases. Examples are given as follows.

The IBM Lotus Domino mail service system is used widely due to its excellent processing performance. Generally, a Notes client in the mail service system receives and sends mails via a Domino server, that is, a system user within the mail service system processes mails on the Domino server based on the Notes client or sends mails via the Domino server.

The type of mails transmitted between system users via the Domino server is usually preferred to be mails in RTF (Rich Text Format) format. The mail format of a RTF mail may be exported to DXL (Domino Extensible Markup Language) format.

The type of mails transmitted between a system user and a non-system user via the Domino server is usually MIME (Multipurpose Internet Mail Extensions) mails. Wherein, a MIME mail generally comprises a mail body in HTML (Hyper Text Markup Language) format.

In the prior art, for terminals not supporting RTF mails, such as some mobile terminals, the Domino server is generally required to perform conversion processing on the RTF mails, such as the conversion from RTF mails to MIME mails, in order for convenience for a terminal user to check mails.

In the course of implementing the present invention, the inventor finds that there are at least the following technical problems in the prior art.

The prior art usually performs no control processing to the display of mails in the course of performing the conversion from a source mail, such as a RTF mail, to a target mail, such as a MIME mail, which leads to difference in the display effects of the target mail and the source mail. In particular, it generally leads to a case that the mail content is displayed disorderly and unsystematically in the displayed target mail and thus the user experiences of target mail recipients degrades. Also, for an information distributor who expects to deliver information, such as product information and activity information, to the target mail recipients via the target mail, it is difficult to reach the information distribution effect as expected since the display effect of the target mail is relatively bad.

### SUMMARY OF THE INVENTION

Embodiments of the present invention provide a method and device for mail processing to resolve a technical problem present in the prior art that the display effect of a first mail is inconsistent with the display effect of a second mail obtained by the conversion from the first mail.

In order to resolve the technical problem as described above, an embodiment of the invention provide a method for mail processing, comprising the steps of:

acquiring a first description information of a first mail, the first description information comprising a first mail content and a first display description information of the first mail content;

acquiring a first format of the first mail and a second format of a second mail; converting the first mail content in the first format into a second mail content in the second format;

converting the first display description information in the first format into a second display description information in the second format; and

obtaining the second mail according to a second description information comprising the second mail content and the second display description information,

wherein the display of the second mail content within the second mail according to the second display description information is consistent with the display of the first mail content within the first mail according to the first display description information.

Optionally, said converting the first display description information in the first format into the second display description information in the second format comprises:

acquiring a display ability description information of a terminal for displaying the second mail; and

deriving the second display description information corresponding to the display ability description information from the first display description information, the first format and the second format.

Optionally, said deriving the second display description information corresponding to the display ability description information from the first display description information, the first format and the second format comprises:

judging whether the first format is the same as the second format or not, and if not, then setting the second display description information supportable by the terminal according to the first display description information.

Optionally, said acquiring the display ability description information of the terminal for displaying the second mail comprises:

acquiring the display ability description information from a preset server or the terminal.

Optionally, said acquiring the first description information of the first mail comprises:

acquiring the first description information which can be parsed out directly from a preset storage region; or

acquiring partial information of the first description information which can be parsed out directly from the preset storage region, and acquiring, according to the index information pertaining to the source mail stored in the preset storage region, the rest information of the first description information from a position indicated by the index information.

Optionally, said converting the first mail content in the first format into the second mail content in the second format comprises:

converting the first mail content into the second mail content supportable by the terminal.

Optionally, said converting the first mail content into the second mail content supportable by the terminal comprises:

parsing out a specified type of content in the first mail content; and

converting the specified type of content into the content supportable by the terminal.

Optionally, after converting the specified type of content into the specified type of content supportable by the terminal, the method further comprises:

storing the specified type of content supportable by the terminal in a specified position.

Optionally, said obtaining the second mail according to the second description information comprising the second mail content and the second display description information comprises:

setting the second mail containing association information which is used for associating the specified type of content in the specified position with the second mail.

Optionally, after setting the second mail containing the association information, the method further comprises:

sending out the second mail; or

sending out the second mail, and sending out the description information of the specified type of content which is not contained directly in the second mail.

Optionally, said acquiring the first format and the second format of the second mail comprises:

obtaining the first format according to mail type of the first mail; and

obtaining the second format according to mail type of the second mail.

In order to resolve the technical problem as described above, an embodiment of the invention provide a device, comprising:

a first acquiring unit for acquiring a first description information of a first mail, the first description information comprising a first mail content and a first display description information of the first mail content;

a second acquiring unit for acquiring a first format of the first mail and a second format of a second mail;

a first conversion unit for converting the first mail content in the first format into a second mail content in the second format according to the information acquired by the first acquiring unit and the second acquiring unit;

a second conversion unit for converting the first display description information in the first format into a second display description information in the second format according to the information acquired by the first acquiring unit and the second acquiring unit; and

a generation unit for obtaining the second mail according to a second description information comprising the second mail content and the second display description information,

wherein the display of the second mail content within the second mail according to the second display description information is consistent with the display of the first mail content within the first mail according to the first display description information.

Optionally, the second conversion unit comprises:

a third acquiring unit for acquiring a display ability description information of a terminal for displaying the second mail; and

a second sub-conversion unit for deriving the second display description information corresponding to the display ability description information from the first display description information, the first format and the second format.

Optionally, the second sub-conversion unit comprises:

a judging unit for judging whether the first format is the same as the second format or not to get a judgment result; and

a setting unit for setting the second display description information supportable by the terminal according to the first display description information based on the judgment result of the judging unit being that the first format is different from the second format.

Optionally, the first conversion unit comprises:

a parsing unit for parsing out a specified type of content in the first mail content; and

a first sub-conversion unit for converting the specified type of content into the specified type of content supportable by the terminal.

Optionally, the device further comprises: a storage unit for storing the specified type of content supportable by the terminal obtained by the first sub-conversion unit.

Optionally, the generation unit comprises:

an association unit for setting the second mail comprising association information which is used for associating the specified type of content supportable by the terminal stored by the storage unit with the second mail.

Optionally, the device further comprises:

a sending unit for sending out the second mail; or for sending out the second mail and sending out the description information of the specified type of content which is not contained directly in the second mail.

As compared with the prior art, the technical solutions provided by embodiments of the present invention have the following beneficial effects:

The method and device for mail processing provided by the embodiments of the present invention obtain the second mail content of the second mail by the conversion based on the first mail content of the first mail, and obtain the second display description information of the second mail by the conversion based on the first display description information of the first mail content by performing the control processing on the displays of the first mail and the second mail, and thus get the second mail according to the second mail content and the second display description information to make the display of the second mail consistent with the display of the first mail, so that user experiences of recipients of the second mail are effectively improved and the expected information distribution effect can be obtained for information distributors who expect to deliver relevant information via the first or the second mail.

Also, the above-described technical solutions provided by the embodiments of the present invention provide the technical solutions of acquiring the first mail content contained in the first description information from multiple aspects, and avoid the case in the prior art that some mail contents within the first mail, such as a RTF mail, is discarded directly, resulting in a loss of the mail content embodied on the second mail, such as a MIME mail. Thus, it is possible to make the second mail recipients see the mail information which is relatively consistent with the information to be expressed by the first mail. Accordingly, for the distributors who distribute information by mails, it is possible to gain the expected information distribution effect.

Furthermore, in the embodiments of the present invention, as to some specified types of contents within the first mail, such as the mail body information with a relatively large amount of information, it is possible not to be sent to the second mail recipients directly via the second mail. Instead, the description information of these specified types of contents is provided, and the target mail recipients select whether to obtain the specified types of contents based on the second mail or not according to their own requirements, which can save transmission resources effectively and save storage resources of the second mail recipients.

In the above-described technical solutions provided by the embodiments of the present invention, the device may be a preset server which is dedicated to performing the mail processing, so that the processing loads of existing servers, such as Domino servers, can be reduced. Or, the technical solutions of the present invention can be implemented by enhancing the processing abilities of existing relevant devices.

### BRIEF DESCRIPTION OF THE DRAWINGS

FIG. 1 is a flowchart of a method for mail processing according to an embodiment of the present invention;

FIG. 2 is a flowchart for processing a mail by using a Notes document according to an embodiment of the present invention;

FIG. 3 is another flowchart for processing a mail based on a Notes document according to an embodiment of the present invention;

FIG. 4 is a structural schematic diagram of a device according to an embodiment of the present invention; and

FIG. 5 is another structural schematic diagram of a device according to an embodiment of the present invention.

### DESCRIPTION OF THE PREFERRED EMBODIMENTS

The reason why it is difficult for the prior art to resolve the technical problems as described above is that the prior art performs no compatibility processing to the displays of the first mail and the second mail converted based on the first mail, leading to difference in the display effects of the first mail and the second mail and even to a case that the second mail is displayed disorderly.

In an embodiment of the present invention, it is considered to perform the compatibility processing to the displays of different mails so as to assure that the displays of different mails are consistent with each other as much as possible in the course of converting the first mail into the second mail.

In the following, technical solutions of the present invention will be described in detail in combination with detailed embodiments and attached drawings.

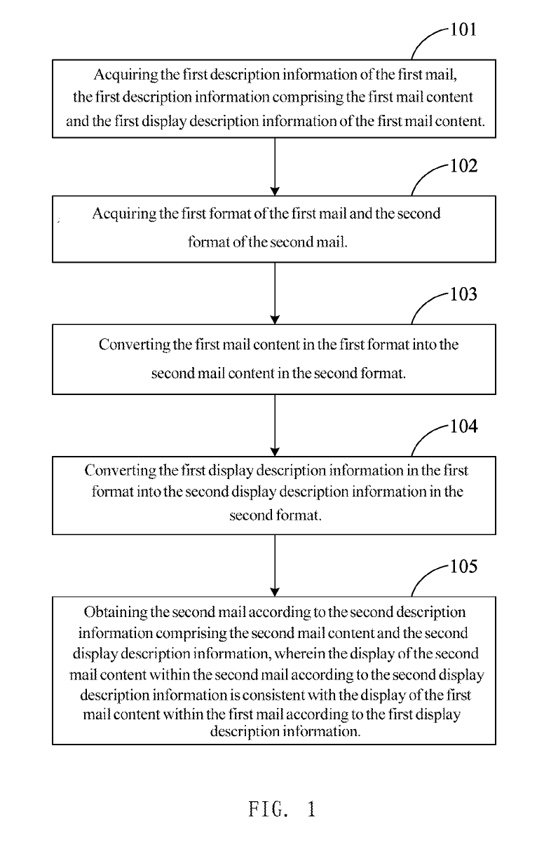

Refer to FIG. 1, which is a flowchart of a method for mail processing according to an embodiment of the present invention. The flow may comprise the following steps.

At step 101, a first description information of a first mail is acquired, the first description information comprising a first mail content and a first display description information of the first mail content.

In the embodiment of the invention, the first display description information may comprise a mail background, a font definition, a table definition and so on.

The first mail content may comprise mail head information and mail body information, wherein the mail body information may comprise multiple types of information, such as plain text information and non-plain text information. The non-plain text information is such as an attachment, an embedded resource, etc in a mail. The embedded resource is such as a picture, a functional module and so on. The functional module is such as a link function, a special mark, a script and so on. The link function is such as document link, OLE (Object Linking and Embedding) and so on.

At step 102, a first format of the first mail and a second format of a second mail are acquired.

Specifically, it is possible to obtain the format of a mail according to the mail type of the mail, for example, a RTF mail is usually in DXL format, and a MIME mail is usually in HTML format.

At step 103, the first mail content in the first format is converted into the second mail content in the second format.

At step 104, the first display description information in the first format is converted into a second display description information in the second format.

At step 105, the second mail is acquired according to a second description information comprising the second mail content and the second display description information, wherein the display of the second mail content within the second mail according to the second display description information is consistent with the display of the first mail content within the first mail according to the first display description information.

In the embodiment of the invention, controlling the display of the second mail according to the first mail comprises producing the second description information based on the first description information of the first mail so as to produce the second mail.

Specifically, in the embodiment of the invention, as to the display, it is possible to acquire the display ability description information of a terminal for displaying the second mail, and combining the first display description information, the first format and the second format to derive the second display description information consistent with the display ability of the terminal. Wherein, the display ability description information may comprise information related to the display function of the terminal, such as the size, the resolution, etc of a display screen. As to the mail content, when necessary, the first mail content may be subjected to a parse processing and then be compiled into information that can be supported by the terminal.

Further, it is possible to judge whether the first format and the second format are the same or not in an actual application. If they are different, it is required to set the second display description information that can be supported by the terminal according to the first display description information. For example, a RTF mail supports DXL format, and a MIME mail directly comprises a HTML mail body, thus it is required to generate the second display description information written in HTML according to the first display description information exported with DXL format. If the first format and the second format are the same, it only needs to set the second display description information consistent with the display ability of the terminal according to the display ability of the terminal.

Specifically, as to the display ability description information of the terminal, it may be acquired from a preset server, or it is possible to receive the relevant information reported by the terminal via a communication with the terminal.

In the embodiment of the invention, the display of the second mail content in the displayed second mail is made to be consistent with the display of the first mail content in the first mail by performing the control processing to the display of the second mail.

In an actual application, it is possible to perform the operation for mail processing as shown in FIG. 1 by enhancing the function of an existing relevant device, such as the Domino server as described above; or it is possible to set a dedicated device to reduce the processing load of the existing relevant device.

In fact, there are other technical problems existed in the prior art. For example, the prior art usually discards some types of content in the first mail or the source mail in the course of mail conversion. For example, the Domino server generally reads only the plain text information in a RTF mail and discards the non-plain text information. Loss of the content of the mail body will result in a problem that the information to be conveyed by the target mail, such as a MIME mail, received by the recipients of the second mail or the target mail is inconsistent with that of the source mail, such as a RTF mail, and the occurrence of the problem is not desired by the information distributor of the target mail and also influences the user experiences of the target mail recipients.

In the embodiment of the invention, a relatively excellent solution for mail processing is provided to acquire the complete first description information of the source mail and set the target mail with relatively complete information as much as possible.

In the following, explanation will be made in detail about a specific implementation of acquiring the first description information in the embodiment of the invention.

In general, the relevant information on the source mail may be stored in a preset storage region. For example, the relevant information of the source mail is usually stored in a Notes document in the above Lotus Domino mail service system. In the embodiment of the invention, in order to acquire the first description information pertainning to the source mail, considering two aspects comprising: acquiring, from the preset storage region, all the information of the first description information that can be obtained directly; or further acquiring, based on the acquired some index information, the rest information of the first description information from the storage position indicated by the index information.

For the case of acquiring from the preset storage region the first description information that can be obtained directly, the following is taken as an example: the first description information containing a part or all of the source mail, such as the mail head information, a part of the mail body information, the first display description information, etc of the first mail content, is exported from the Notes document.

The specific processing of acquiring the rest of the first description information may comprise: finding whether the rest information which is not contained in the exported information exists or not in the Notes document and acquiring the rest information; and/or obtaining the rest information which is not directly contained in the exported information according to the found index information.

Furthermore, for the case that the first content contains multiple types of contents, some specified types of contents may be parsed out from the exported information and stored in specified positions. When the target mail is generated, association information is set within the target mail to associate the target mail with the specified types of contents in the specified positions.

In a practical application, the specified types of contents may be specifically contents with relatively large amount of information such as non-plain text information like attachments with a relatively large amount of information, high definition pictures, etc. Thus, in a practical application, in order to save transmission resources as much as possible, when sending the target mail, it is possible not to send the specified contents together with the target mail. Instead, the description information for the specified types of contents, such as the name list for the specified types of contents, may be set within the target mail. After receiving the target mail, the target mail recipients select interesting contents according to their own desires and acquire the related specified types of contents from the specified positions based on the association information.

An instance that the first description information of a RTF mail acquired from the Notes document is mostly the first mail content is taken as an example to mainly explain the course of acquiring the mail body information of the RTF mail.

In a practical application, the Notes document may contain directly all of the mail body information pertaining to the RTF mail, or may contain directly only a part of the mail body information of the RTF mail and the other part of the mail body information is needed to be acquired from other positions through the index information in the Notes document. Therefore, in a practical application, it is possible to set as required to acquire only the mail body information of the RTF mail contained directly in the Notes document, or to set to not only acquire the mail body information of the RTF mail contained directly in the Notes document, but also further obtain other mail body information of the RTF mail from the positions indicated by the index information.

Specifically, the operation of acquiring the mail body information directly from the Notes document may comprise: getting the exported information which is specifically one mail file from the Notes document; then further finding in the Notes document and determining whether the mail body information of the RTF mail which is not exported exists or not in the Notes document, so as to acquire all of the mail body information pertaining to the RTF mail as much as possible.

The embodiment of the present invention will take a RTF mail and a MIME mail which may be contained in a Notes document as an example to explain the mail processing solution provided by the embodiment of the invention, however, the technical solution provided by the embodiment of the invention is not limited to be applied in the IBM Lotus Domino mail service system.

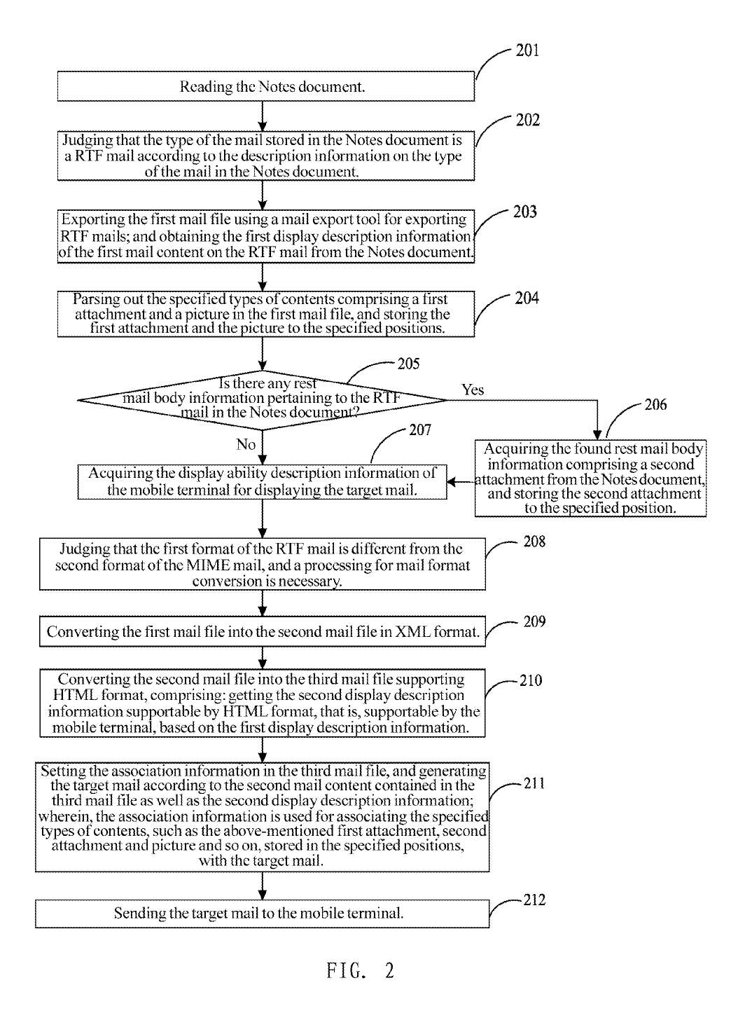

Refer to FIG. 2, which is a flowchart for processing a mail based on a Notes document according to an embodiment of the present invention. In the flow, the source mail is specifically a RTF mail, and the target mail is specifically a MIME mail. The flow may comprise the following steps.

At step 201, a Notes document is read.

At step 202, it is judged that the type of the mail stored in the Notes document is a RTF mail according to the description information on the type of the mail in the Notes document.

At step 203, a first mail file is exported using a mail export tool for exporting RTF mails; and a first display description information of a first mail content on the RTF mail is obtained from the Notes document.

In the present embodiment, the first display description information is exemplified to mainly comprise the display position of the mail body information. In a practical application, it is possible to further consider other information such as the background color of the mail body and so on.

In the step 203, the mail export tool may be an existing Notes development interface for exporting a RTF mail from a Notes document or other realizable techniques capable of exporting a RTF mail from a Notes document.

In the step 203, the first mail content within the exported first mail file comprises multiple types of contents, such as plain text information, pictures and attachments and so on.

At step 204, content of specified types comprising a first attachment and a picture in the first mail file is parsed out, and the first attachment and the picture are stored to the specified positions.

At step 205, it is further found whether the rest mail body information pertaining to the RTF mail exists or not in the Notes document, and if it exists, going to step 206; otherwise, going to step 207.

In the step 205, the finding operation may be performed based on keywords related to the RTF mail or attributes of the RTF mail.

At the step 206, the found rest mail body information comprising a second attachment is acquired from the Notes document, and the second attachment is stored to the specified position.

Further, in a practical application, it is possible to compile the specified type of content stored in the specified position into the content supportable by a mobile terminal as required.

At the step 207, the display ability description information of the mobile terminal for displaying the target mail is acquired.

In a practical application, it may be set that the mobile terminal needs to report its display ability description information to a relevant server when applying for a relevant service. Thus, in the present embodiment, the display ability description information of the mobile terminal may be acquired from the relevant server, and the information may comprise specifically the display size of the display screen of the mobile terminal, the mobile terminal's ability of supporting software, for example, general mobile terminal not supporting some marks, scripts, etc specific to Domino.

At step 208, it is judged that a first format of the RTF mail is different from a second format of the MIME mail, and it needs to perform a processing for mail format conversion.

In the present embodiment, it needs to convert the mail in RTF format into the MIME mail in HTML format.

At step 209, the first mail file is converted into the second mail file in XML format.

In the embodiment of the present invention, the conversion technique employed in the step 209 is Domino DTD (Document Type Definition). Generally, there are multiple types of Domino DTD versions, and the Domino DTD version employed in the embodiment of the invention is the version applicable by the first mail file.

At step 210, the second mail file is converted into a third mail file supporting HTML format, comprising: obtaining the second display description information supportable by HTML format, that is, supportable by the mobile terminal, based on the first display description information.

In the step 210, the second display description information may be obtained based on XSLT (Extensible Stylesheet Language Transformations) technique. For example, the mail content display description information, such as the description for the specific screen width in XML format, the description for the specific background color in XML format, the description for the display position of the specific picture in XML format, etc, is converted into HTML format applicable by the display ability of the mobile terminal based on XSLT.

At step 211, the association information is set in the third mail file, and the target mail is generated according to the second mail content contained in the third mail file as well as the second display description information; wherein, the association information is used for associating the specified types of contents, such as the above-mentioned first attachment, second attachment and picture and so on, stored in the specified positions into the target mail.

Upon specific implementation, the specific form of the association information may be hyperlink address or other forms. In the present embodiment, it may save bandwidth resources that associating the specified types of contents with the target mail through the association information, instead of carrying them by the target mail to the target mail recipients.

In addition, in a practical application, in order for the convenience for the target mail recipients to know which mail content are not carried directly by the target mail, the description information for the mail content which are not carried directly can be sent to the target mail recipients. The description information is for example the name list of the mail content.

In a practical application, it can be set as required that some contents with relatively large amount of information are carried directly by the target mail.

At step 212, the target mail is sent to the mobile terminal.

In the flow as shown in FIG. 2, in the course of acquiring the mail body information pertaining to the source mail, not only the mail body information contained in the exported information is collected, but also the rest mail body information not exported in the Notes document is further collected, thereby all of the mail body information pertaining to the RTF mail is acquired as much as possible, such that the set target mail can embody the information to be expressed by the source mail.

In the flow as shown in FIG. 2, based on the conversion from DXL format to HTML format, it is possible to enable the displayed MIME mail to present orderly the information to be expressed in the RTF mail so as to improve user experiences.

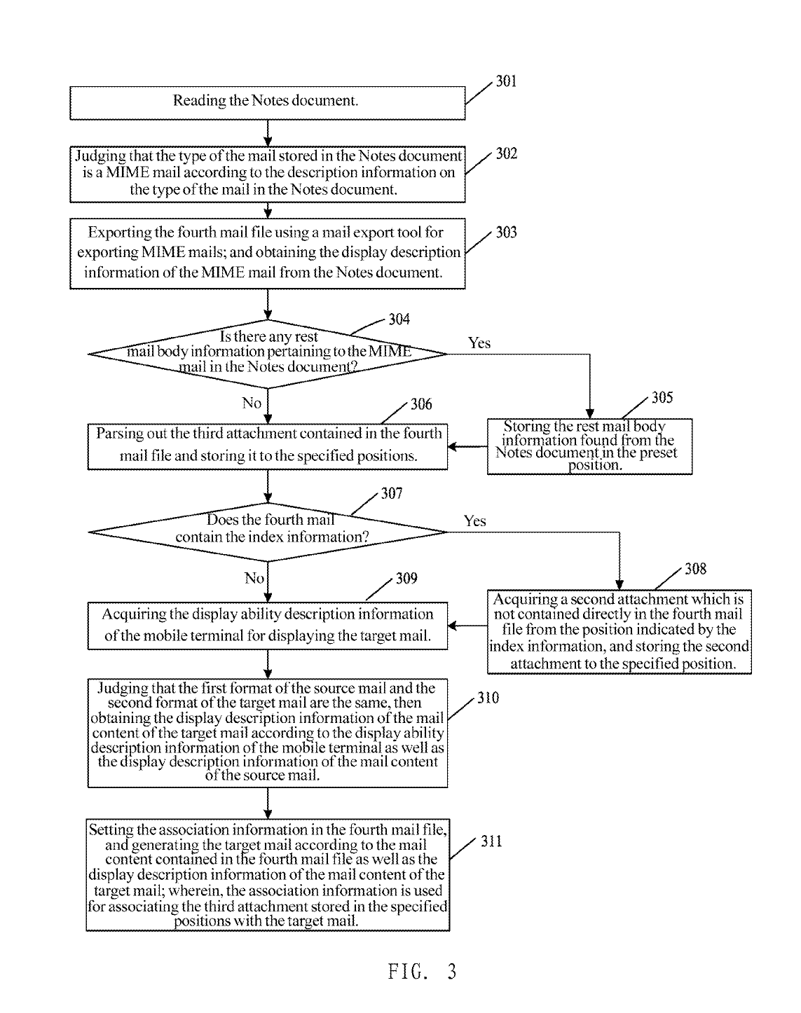

Refer to FIG. 3, which is another flowchart for processing a mail based on a Notes document in an embodiment of the present invention. In the flow, both the first format of the source mail and the second format of the target mail are HTML format. The flow may comprise the following steps:

At step 301, a Notes document is read.

At step 302, it is judged that the type of the mail stored in the Notes document is a MIME mail according to the description information on the type of the mail in the Notes document.

At step 303, a fourth mail file is exported using a mail export tool for exporting MIME mails; and the display description information of the MIME mail is obtained from the Notes document.

In the step 303, the mail export tool may be an existing Notes development interface for exporting a MIME mail from a Notes document or other realizable techniques capable of exporting a MIME mail from a Notes document.

In the step 303, the exported fourth mail file comprises plain text information and a third attachment.

At step 304, it is found whether the rest mail body information pertaining to the MIME mail exists or not in the Notes document, and if it exists, going to step 305; otherwise, going to step 306.

At step 305, the rest mail body information found from the Notes document is stored to the preset position.

At the step 306, the third attachment contained in the fourth mail file is parsed out and stored to the specified positions.

At the step 307, it is examined whether the index information is contained within the fourth mail file or not, and if it is contained, going to step 308; otherwise, going to step 309.

At the step 308, a second attachment which is not contained directly in the fourth mail file is acquired from the position indicated by the index information, and the attachment is stored to the specified position.

In the embodiment of the present invention, the index information is specifically the link address for reference object in the fourth mail file.

At the step 309, the display ability description information of the mobile terminal for displaying the target mail is acquired.

In the present embodiment, the specific implementation of the step 309 may be referred to the detailed description regarding the specific implementation of the step 207 as described above, and will not be described in redundancy.

At step 310, it is judged that the first format of the source mail and the second format of the target mail are the same, then the display description information of the mail content of the target mail is obtained according to the display ability description information of the mobile terminal as well as the display description information of the mail content of the source mail.

In the present embodiment, since the mail formats of the source mail and the target mail are the same, there is no need to perform a conversion processing on languages for describing the mail content display description information, and it only needs to set the mail content display description information of the target mail based on the display ability description information.

At step 311, the association information is set in the fourth mail file, and the target mail is generated according to the mail content contained in the fourth mail file as well as the display description information of the mail content of the target mail; wherein, the association information is used for associating the third attachment stored in the specified positions into the target mail.

The description about the association information may be referred to the related description about the above-described step 211, and will not be given in redundancy.

At step 312, the target mail is sent to the mobile terminal.

In the flow as shown in FIG. 3, based on the mobile terminal's display ability, the mail content display description information on the target mail which can be supported by the mobile terminal is set such that the display of the mail content of the target mail is substantially the same as the display of the mail content of the source mail, thereby the expected mail display effect can be gained and user experiences of the target mail recipients can be improved.

In addition, as to the collection of the mail content pertaining to the source mail, the needed mail information is collected from not only the Notes document, but also based on the index information, so that the set target mail can embody all of the mail information pertaining to the source mail.

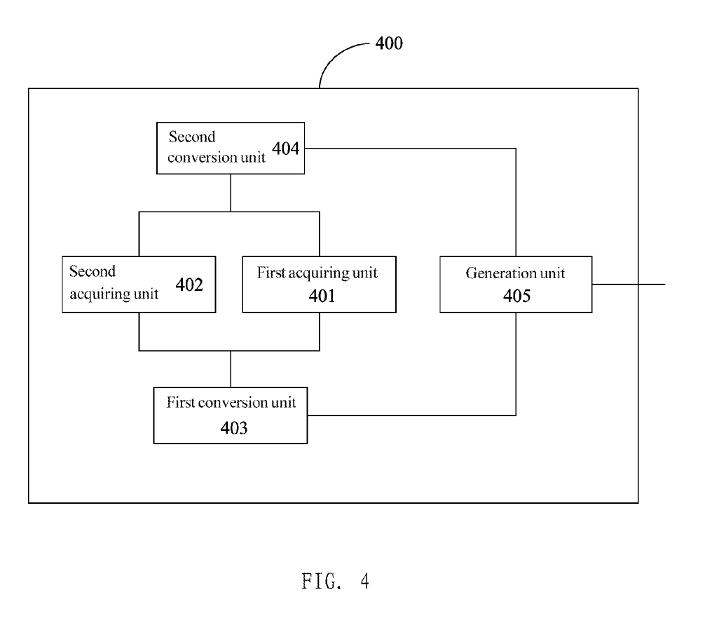

The embodiment of the present invention further provides a device. Refer to FIG. 4, which is a structural schematic diagram of the device. In FIG. 4, the device 400 may comprise:

a first acquiring unit 401 for acquiring a first description information of a first mail, the first description information comprising a first mail content and a first display description information of the first mail content;

a second acquiring unit 402 for acquiring a first format of the first mail and a second format of a second mail;

a first conversion unit 403 for converting the first mail content in the first format into a second mail content in the second format according to the information acquired by the first acquiring unit 401 and the second acquiring unit 402;

a second conversion unit 404 for converting the first display description information in the first format into a second display description information in the second format according to the information acquired by the first acquiring unit 401 and the second acquiring unit 402; and

a generation unit 405 for obtaining the second mail according to a second description information comprising the second mail content and the second display description information;

wherein, the display of the second mail content within the second mail according to the second display description information is consistent with the display of the first mail content within the first mail according to the first display description information.

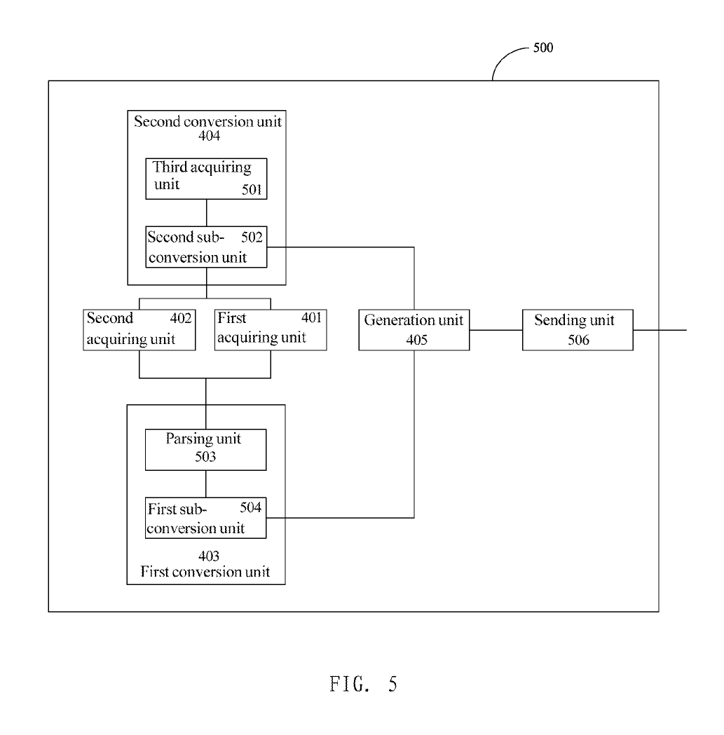

Refer to FIG. 5, which is another structural schematic diagram of a device according to an embodiment of the present invention. In FIG. 5, the second conversion unit 404 comprises:

a third acquiring unit 501 for acquiring the display ability description information of a terminal for displaying the second mail; and

a second sub-conversion unit 502 for deriving the second display description information corresponding to the display ability description information from the first display description information, the first format and the second format.

The second sub-conversion unit 502 comprises (not shown in the figure):

a judging unit for judging whether the first format and the second format are the same or not to get a judgment result; and

a setting unit for setting the second display description information supportable by the terminal according to the first display description information, based on the judgment result of the judging unit being that the first format is different from the second format.

The first conversion unit 403 comprises:

a parsing unit 503 for parsing out a specified type of content in the first mail content; and

a first sub-conversion unit 504 for converting the specified type of content to a specified type of content which can be supported by the terminal.

The device 500 further comprises (not shown in the figure) a storage unit for storing the specified type of content, which can be supported by the terminal, obtained by the first sub-conversion unit 504.

The generation unit 405 comprises (not shown in the figure):

an association unit for setting the second mail comprising association information, said association information is used for associating the specified type of content, which can be supported by the terminal, stored by the storage unit with the second mail.

The device further comprises:

a sending unit 506 for sending out the second mail, or for sending out the second mail and sending out the description information of the specified type of content which is not directly contained in the second mail.

With the above description of implementations, those skilled in the art can clearly understand that the present invention can be implemented by a manner of software plus a necessary general hardware platform, and, of course, by hardware, however, the former is a better implementation in many cases. Based on such understanding, the technical solutions of the present invention essentially or, in other words, a part thereof contributing to the prior art can be embodied in a form of a software product, wherein the software product is stored in a storage medium and comprises several instructions to make one terminal perform the methods as described in respective embodiments of the present invention.

What described above is only preferred implementations of the present invention, and it should be noted that it is possible for those of ordinary skill in the art to further make several improvements and refinements, which should be considered as falling into the protection scope of the present invention, without departing from the principle of the present invention.

What is claimed is:

1. A method for mail processing, comprising:
acquiring a first description information of a first mail, the first description information comprising a first mail content and a first display description information of the first mail content;
acquiring a first format of the first mail and a second format of a second mail;
converting the first mail content in the first format into a second mail content in the second format;
converting the first display description information in the first format into a second display description information in the second format; and
obtaining the second mail according to a second description information comprising the second mail content and the second display description information,
wherein the display of the second mail content within the second mail according to the second display description information is consistent with the display of the first mail content within the first mail according to the first display description information.

2. The method according to claim 1, wherein, said converting the first display description information in the first format into the second display description information in the second format comprises:
acquiring a display ability description information of a terminal for displaying the second mail; and
deriving the second display description information corresponding to the display ability description information from the first display description information, the first format and the second format.

3. The method according to claim 2, wherein, said deriving the second display description information corresponding to the display ability description information from the first display description information, the first format and the second format comprises:
judging whether the first format is the same as the second format or not, and if not, setting the second display description information supportable by the terminal according to the first display description information.

4. The method according to claim 2, wherein, said acquiring the display ability description information of the terminal for displaying the second mail comprises:
acquiring the display ability description information from a preset server or the terminal.

5. The method according to claim 2, wherein, said acquiring the first description information of the first mail comprises:
acquiring the first description information which can be parsed out directly from a preset storage region; or
acquiring partial information of the first description information which can be parsed out directly from the preset storage region, and acquiring the rest information of the first description information from the position indicated by an index information pertaining to a source mail stored in the preset storage region according to the index information.

6. The method according to claim 2, wherein, said converting the first mail content in the first format into the second mail content in the second format comprises:
converting the first mail content into the second mail content supportable by the terminal.

7. The method according to claim 6, wherein, said converting the first mail content into the second mail content supportable by the terminal comprises:
parsing out a specified type of content in the first mail content; and
converting the specified type of content into the content supportable by the terminal.

8. The method according to claim 7, wherein, after converting the specified type of content to the specified type of content supportable by the terminal, the method further comprises:
storing the specified type of content supportable by the terminal in a specified position.

9. The method according to claim 8, wherein, said obtaining the second mail according to the second description information comprising the second mail content and the second display description information comprises:
setting the second mail containing association information which is used for associating the specified type of content in the specified position with the second mail.

10. The method according to claim 9, wherein, after setting the second mail containing the association information, the method further comprises:
sending out the second mail; or
sending out the second mail, and sending out the description information on the specified type of content which is not contained directly in the second mail.

11. The method according to claim 1, wherein, said acquiring the first format and the second format of the second mail comprises:
obtaining the first format according to a mail type of the first mail; and
obtaining the second format according to a mail type of the second mail.

12. A device, comprising:
a first acquiring unit for acquiring a first description information of a first mail, the first description information comprising a first mail content and a first display description information of the first mail content;
a second acquiring unit for acquiring a first format of the first mail and a second format of a second mail;
a first conversion unit for converting the first mail content in the first format into a second mail content in the second format according to the information acquired by the first acquiring unit and the second acquiring unit;
a second conversion unit for converting the first display description information in the first format into a second display description information in the second format according to information acquired by the first acquiring unit and the second acquiring unit; and
a generation unit for obtaining the second mail according to a second description information comprising the second mail content and the second display description information,
wherein the display of the second mail content within the second mail according to the second display description information is consistent with the display of the first mail content within the first mail according to the first display description information.

13. The device according to claim 12, wherein, the second conversion unit comprises:
a third acquiring unit for acquiring the display ability description information of a terminal for displaying the second mail; and
a second sub-conversion unit for deriving the second display description information corresponding to the display ability description information from the first display description information, the first format and the second format.

14. The device according to claim 13, wherein, the second sub-conversion unit comprises:
a judging unit for judging whether the first format is the same as the second format or not to get a judgment result; and
a setting unit for setting the second display description information supportable by the terminal according to the first display description information, based on the judgment result of the judging unit being that the first format is different from the second format.

15. The device according to claim 13, wherein, the first conversion unit comprises:
a parsing unit for parsing out a specified type of content in the first mail content; and
a first sub-conversion unit for converting the specified type of content into the specified type of content supportable by the terminal.

16. The device according to claim 15, wherein, the device further comprises:
a storage unit for storing the specified type of content supportable by the terminal obtained by the first sub-conversion unit.

17. The device according to claim 16, wherein, the generation unit comprises:
an association unit for setting the second mail comprising association information which is used for associating the specified type of content supportable by the terminal stored by the storage unit with the second mail.

18. The device according to claim 17, wherein, the device further comprises:
a sending unit for sending out the second mail; or for sending out the second mail and sending out the description information of the specified type of content which is not contained directly in the second mail.
